(19) United States
(12) Patent Application Publication
(10) Pub. No.: US 2024/0044732 A1
(43) Pub. Date: Feb. 8, 2024

(54) CONFORMABLE IMPEDANCE SENSOR ASSEMBLY AND SENSOR SYSTEM

(71) Applicant: Teiimo GmbH, Germering (DE)

(72) Inventors: Markus Strecker, Herrsching (DE); Sven Hitschold, München (DE); Clemens Satzger, Germering (DE)

(73) Assignee: Teiimo GmbH, Germering (DE)

(21) Appl. No.: 18/039,863

(22) PCT Filed: Dec. 1, 2021
(86) PCT No.: PCT/EP2021/083776

§ 371 Date: Jun. 1, 2023

Related U.S. Application Data
(60) Provisional application No. 63/120,038, filed on Dec. 1, 2020.

(51) Int. Cl. G01L 5/16; G01L 1/14

(52) U.S. Cl. CPC G01L 5/16; G01L 1/142

(57) ABSTRACT

A conformable impedance sensing system includes at least two sensors, each having a different sensing behavior and each formed of stretchable, conformable materials. A pressure sensitive impedance (PSI) sensor and a stretch sensitive impedance (SSI) sensor are collectively disposed and both connected to a reference electrode and to readout electronics configured to read impedance signals from the sensors to reduce externally induced signal shifts and cross sensitivity effects. A sensor assembly includes a pressure sensor having a pressure circuit with a sensing impedance sensitive to external pressure and sensitive to another external influence and a reference circuit having a reference impedance insensitive to external pressure but sensitive to the other external influence. A cumulative signal dependent on the external pressure but independent from the other external influence is derived based upon a comparison of the sensing impedance and the reference impedance.

### CROSS REFERENCE TO RELATED APPLICATIONS

This application claims priority from U.S. Provisional Application Ser. No. 63/120,038, titled CONFORMABLE IMPEDANCE SENSOR SYSTEM, filed Dec. 1, 2020, incorporated herein by reference.

### FIELD OF THE INVENTION

This invention relates to conformable sensors and an arrangement of conformable impedance sensors, referred to herein as an impedance sensor system (ISS), comprising primarily one or multiple conformable impedance sensors that are constructed with conformable material layers.

### BACKGROUND OF THE INVENTION

Today's technologies are very powerful with respect to sensing capabilities, especially pressure sensors based on silicon-technology, formed with micromachining techniques or based on ceramic materials that are strongly piezo-resistive or piezoelectric. These sensors are precise when they can be applied flat on a surface or integrated into an electronics assembly or housed by plastic or metal materials. But, measurement on a curved surface may cause these technologies to fail, as they are strongly dependent to bending, and thus readings are incorrect or not possible.

The same is true for measurements in three-dimensional shapes. A bendable sensor can be bent, but bending a three-dimensional sensor requires the top of the sensor to stretch while the bottom of the sensor needs to compress or stretch as well (dependent on the object it is attached to). As this is not or barely possible, the shape change introduces stress and three-dimensional change of the dimensions induce a high sensor signal due to the implied mechanical stress that is picked up by the sensors. These sensors could as well be fabricated in a bent shape, but then affixed to this given shape. If small sensors are assembled in a pattern to a curved surface that is bendable, a quasi-bendable structure is achieved, however, the individual sensor elements remain stiff or/or hard.

Accordingly, there is a need in the art for sensors composed of conformable materials that allow for stretch.

### SUMMARY OF THE INVENTION

One aspect of the invention relates to a conformable impedance sensing system comprising at least two sensors, each having a different sensing behavior and each formed of stretchable (conformable) materials. The conformable impedance sensor system may include a pressure-sensitive impedance (PSI) sensor and a stretch-sensitive impedance (SSI) sensor, disposed in a stack or in close proximity to one another. Both the PSI and the SSI sensors are connected to a reference electrode. Readout electronics are connected to the PSI sensor, the SSI sensor, and the reference electrode and are configured to read impedance signals from the PSI and SSI sensors to reduce externally induced signal shifts and cross sensitivity effects. Because both the PSI sensor and the SSI sensor are sensitive to different mechanical effects (pressure and stretch), but both are sensitive to other common stimuli (like for example electromagnetic fields or temperature), external disturbances relating to correlated changes in both signals are canceled out by algorithmic calculations.

The conformable impedance sensor system may further include a shielding electrode connected to the readout electronics and covering the SSI and the PSI on one (or both) side(s), wherein the shielding electrode renders one or both of the SSI and the PSI impedances insensitive or sensitive to external capacitive field changes. A conformable electrical insulation layer may envelop the at least two sensors. The system may be attached to a conformable electrical conducting wire, such as meandered metallic cables, such as shielded cables, that are guided by a textile ribbon and connected to the sensors system using a conformable, electrically-conductive glue. The PSI and the SSI may share common components. The ISS may further include an electrode configured to detect proximity to an approaching object or an electrode matrix configured to detect proximity to an approaching object and its direction.

Another aspect of the invention includes a sensor assembly configured to be disposed between a first object and a second object for detecting pressure exerted by the first object on the second object. The sensor assembly comprises at least one pressure sensor and at least one reference circuit. The at least one pressure sensor comprises at least one pressure circuit having a sensing impedance dependent on the external pressure and at least one other external influence acting on the sensor assembly. The at least one reference circuit has a reference impedance independent from the external pressure but dependent on the at least one other external influence. The sensor assembly is configured to derive a cumulative signal dependent on the external pressure but independent from the at least one other external influence based upon a comparison of the sensing impedance and the reference impedance.

The pressure circuitry may be arranged in close proximity within a range of typically 1 mm to 5 cm to the reference circuitry. The pressure circuitry and the reference circuitry may share common components. The pressure circuitry may include a sensing capacitor having a capacitance that is dependent on the external pressure. The reference circuitry may include a reference capacitor having a capacitance that is essentially independent from (insensitive to) the external pressure. The pressure sensor comprises a first electrode layer that is at least partially conductive, a second electrode layer that is at least partially conductive, and a dielectric layer arranged between the first electrode layer and the second electrode layer, wherein the electrode layers and the dielectric layer preferably extend in essentially parallel planes. The dielectric layer may have a compressible sensing portion, preferably comprising at least one gas- (e.g. air-) filled void.

At least one of the first electrode layer and the second electrode layer may have a conductive sensing area forming the sensing capacitor, and a conductive reference area separated from the sensing area by an insulating area and forming the reference capacitor, wherein the surface area of the sensing area facing the other electrode layer corresponds to the surface area of the reference area facing the other electrode layer. The sensing portion may be arranged between the sensing area and an opposing area of the respective other electrode layer. The dielectric layer may have an incompressible reference portion arranged between the reference area and an opposing area of the respective other electrode layer. The term “incompressible” as used herein should be understood to include materials that are essentially incompressible—i.e. have a negligible amount of compressibility (e.g. less than 1% compressible in the range of forces it will see in normal use. At least one electrode layer may have a central sensing area and a peripheral reference area at least partially running around the sensing area. The central sensing area may be rectangular. The thickness of the reference capacitor in a direction perpendicular to the reference area may differ from the thickness of the sensing capacitor in a direction perpendicular to the sensing area. The reference capacitor may be thinner than the sensing capacitor.

The sensor assembly may further comprise at least one at least partially conductive shielding layer arranged on a side of at least one of the conductive layers opposite to the dielectric layer and separated from the conductive layer by a further dielectric layer, and may further comprise means to adapt the electric potential of the shielding to that of the one electrode layer, which may comprise the sensing area and the reference area. The the sensing capacitor, the reference capacitor and/or the at least one shielding layer may be at least partially embedded in a dielectric, in particular, in which a portion of the dielectric is water impermeable and/or gas permeable.

The pressure sensor may be conformable to the structure of the first and second objects, such as wherein the pressure sensor is bendable. At least one of the electrode layers, the dielectric layer, the shielding layer and the dielectric are at least partially composed of a conformable (bendable and stretchable) material, such as silicone. The pressure sensor may be connected to an external device, such as via low ohmic wiring or wirelessly. Conductive wiring may be electrically connected to at least one of the electrode layers via a soft conductive glue, such as silicone glue. The wiring may be at least partially stretchable or conformable and/or shielded, or it may be printed. The external device may be configured to charge the sensing capacitor and/or the reference capacitor and to discharge the sensing capacitor and/or the reference capacitor to a collecting capacitor, such as a collecting capacitor having a capacitance greater than a capacitance of the sensing capacitor and/or the reference capacitor.

The external device may be configured to determine a first number of charge-discharge cycles needed to charge the collecting capacitor to a predetermined electric potential via the sensing capacitor as a cumulative signal, and a second number of charge-discharge cycles needed to charge the collecting capacitor to a predetermined potential via the reference capacitor after the reference capacitor and the collecting capacitor have been discharged as a reference signal, and to determine external pressure by processing the first and second number of charge and discharge cycles.

In embodiments of the sensor assembly, the pressure sensor may comprise a first electrode layer that is at least partially conductive, a second electrode layer that is at least partially conductive, and a dielectric layer arranged between the first electrode layer and the second electrode layer, wherein the electrode layers and the dielectric layer extend in essentially parallel planes and each layer is formed of stretchable (conformable) materials. A sensor system configured to be disposed between a first object and a second object for detecting pressure exerted by the first object on the second object may comprise a sensor assembly according to the foregoing embodiments. Such a sensor system may include the dielectric layer arranged between the first electrode layer and the second electrode layer comprising air and a second material, which second material is elastic and conformable but not compressible. The second material may define a plurality of pillar structures separated by air gaps, wherein deformability of the pillar structures renders the dielectric layer compressible as a whole.

Any of the sensor assemblies or sensor systems as described herein may be include the sensor assembly mounted to a fabric patch that holds wiring that connects the sensor to the read out electronics and that defines a pocket or fixation for the read out electronics, such that the patch can be positioned together with the electronics on the first object and such that a second object can apply pressure to the assembly that can be measured. In one embodiment, the fabric may comprise a sock or sleeve configured to be worn on the human body, such that pressure exceeded by a garment or a wound dressing placed above the sensor can be measured.

### BRIEF DESCRIPTION OF THE DRAWINGS

Exemplary embodiments of the invention are shown in the drawings wherein like reference numerals are referred to identical or equivalent features. In the drawings

FIG. 1A is a schematic cross-sectional illustration of an exemplary pressure sensor for an ISS having a first shielding variant.

FIG. 1B is a schematic cross-sectional illustration of an exemplary pressure sensor for an ISS having a second shielding variant.

FIG. 1C is a schematic cross-sectional illustration of an exemplary pressure sensor for an ISS having a third shielding variant.

FIG. 1D is a schematic cross-sectional illustration of an exemplary pressure sensor for an ISS without shielding.

FIG. 2 is a schematic plan view illustration of a conductive layer comprising a sensing area and a reference area of an exemplary pressure sensor.

FIG. 3 is a schematic illustration of a first conductive layer, second conductive layer and shielding layer of an exemplary pressure sensor.

FIG. 4A is a graph of the number of charge-discharge cycles (cumulative signal) of a sensing capacitor (upper line) and number of charge-discharge cycles of a reference capacitor (lower line) vs. time used in a method of determining external pressure using an exemplary ISS.

FIG. 4B is a graph of absolute pressure values obtained by using the difference between the cumulative signal and the reference signal of FIG. 4A as an input for a predetermined calibration curve.

FIG. 5 is a schematic illustration of an exemplary ISS embodiment.

FIG. 6 is a schematic illustration of an exemplary embodiment comprising multiple ISS.

FIG. 7 is a schematic illustration of the ISS of FIG. 5 in use in a compression shirt.

FIG. 8 is a schematic illustration of the ISS of FIG. 6 in use in a swipe sensor.

FIG. 9 is a schematic illustration of an exemplary ISS stretch sensor.

FIG. 10 is a schematic illustration of an ISS stretch sensor in an application for measuring a joint angle.

FIG. 11 is a schematic illustration of an exemplary pressure sensor in an artificial skin application (i.e. a sensor glove).

FIG. 12 is a schematic illustration of an exemplary sensor can be applied among two balloons.

FIG. 13 is a schematic illustration of an exemplary matrix array of sensors.

FIG. 14A is a schematic illustration of an exemplary ISS embodiment having a closed structure.

FIG. 14B is a schematic illustration of an exemplary ISS embodiment having an open structure.

FIG. 14C is a schematic illustration of an exemplary ISS embodiment having a membrane for gas exchange.

FIG. 15 is a schematic illustration of an exemplary ISS in an application comprising a combined approximation and pressure sensor.

FIG. 16 is a schematic illustration of an exemplary equivalent circuit diagram associated with an embodiment of the invention.

FIG. 17A is a schematic cross-sectional illustration of an exemplary pressure sensor having a body electrode located above the ground or shield electrode.

FIG. 17B is a schematic cross-sectional illustration of an exemplary pressure sensor having an uninsulated shield electrode that forms a body electrode.

FIG. 18A is a schematic cross-sectional illustration of an exemplary pressure sensor having a textile area for attachment to a garment.

FIG. 18B is a schematic cross-sectional illustration of an exemplary pressure sensor having a textile area for attachment to a garment and an uninsulated shield electrode.

### DETAILED DESCRIPTION OF THE INVENTION

Exemplary ISS embodiments may be particularly useful in applications where the shape of a flat hard sensor is less desirable, such as bent shapes, irregular shapes or even shapes that change during the time of a measurement. Two main measurement scenarios may be targeted, one for the measurement of pressure applied to a surface between two soft objects, bodies or corps or in a second form the stretching of the measurement area or the change of a distance between two moving points the system is affixed to. The system conforms to the shape of an object where it is affixed to or attached to and can measure changes in pressure exerted by a first object on a second object or measure a change in lateral distance between two points or expansion of the object that it is attached to. The objects may be of a soft or partially soft nature and the sensor system ideally does not have hard or partially sharp edges (as, for example, would be present in a hard flexible sensor) that would wear off the surface or alter the surface of a soft object. For example, embodiments of the sensors as described herein may be placed between two inflatable balloons and measure the pressure between the two objects or the stretch of the objects while being inflated, at the same time the ISS will remain soft and does not impact the outer shell with a hard corner or a hard structure that would ultimately destroy the balloon. Due to the soft nature of the sensor, the pressure exerted by the sensor on the objects in contact therewith (e.g. balloons, per the example discussed above) will be distributed more even than if it were with a hard sensor placed between the objects. Another advantage is that the sensor can conform to and with the shape of the objects it is affixed to. If for example a balloon gets hit by an external force and conforms, the sensor will follow the change in shape of the object it is affixed to. It should be understood that the description of the functions of the inventive system with respect to “balloons” is an illustrative example only, and that that the actual objects between which the sensor is disposed are not limited to objects of any specific type or character, and include but are not limited to the various other exemplary embodiments as discussed herein.

Another characteristic of an exemplary ISS embodiment is that the material can be made “Sticky” on the outer surface of the ISS sensor, and the stickiness can even be modified in production. One advantage of such a construction is that a sensor stays on most surfaces it is placed to and follows the shape of the objects below or of the objects it is placed in between.

An ISS embodiment placed between a first and a second object measures the pressure between the two objects or the stretch of the object (the change in length/distance between two fix points or over the length of the sensor). The targeted applications mainly (but not exclusively) benefit from use of a sensor that can conform to the shape of a first object, wherein the shape is not a straight surface.

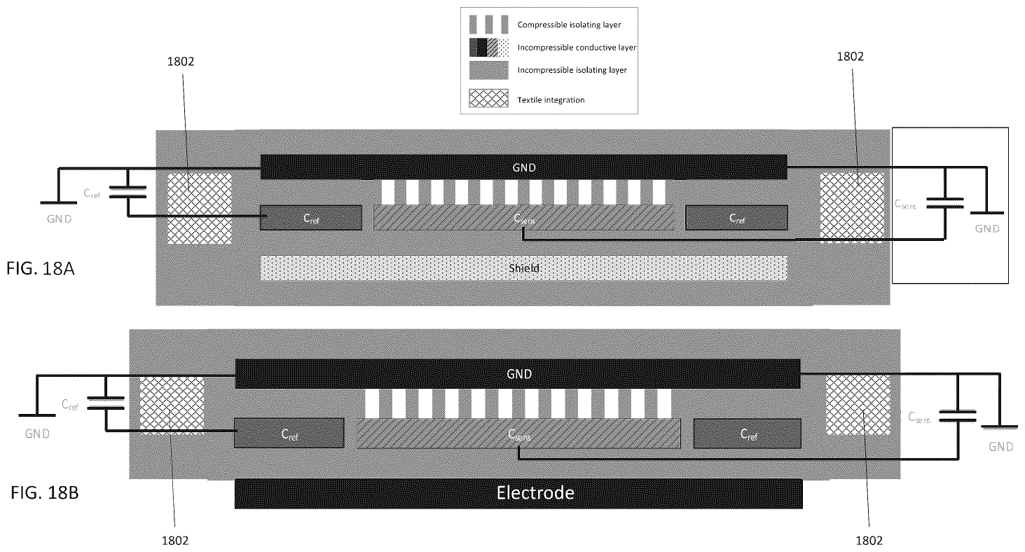

The ISS can be permanently affixed to a fabric base and used together with the fabric as a base in various applications. The affixed fabric may be stretchable as is the ISS or it may be stretchable in only one direction, not in a second direction. Fixation to the related fabric can be realized with conformable glue (for example silicone or one of the ISS layers is entirely fixed to a fabric(-patch) within the fabrication process. The system may be affixed with a sewing line if prepared accordingly in the fabrication process, such as by integrating a small fabric patch 1802 into the ISS structure during fabrication, as depicted in FIGS. 18A and 18B.

The term “read out electronics” is further used to describe an electronics component, which may be embedded with (e.g. in a garment) or otherwise connected to the ISS to read out the signals of the sensor system (for example impedance) and may have further electronic capabilities, such as for example, storing data, filtering and analyzing data, performing algorithmic work, combining the data with data from additional sensors as for example heartrate, SPO2, blood pressure or sending data wireless or via wired connections to other electronic systems. Other electronic systems may be a cloud system that further treats the data and calculates information from the wearer. The cloud system (i.e. one or more processors in the form of computer servers accessible via a communication network such as the internet) may store time series data over a longer time period that allows for detecting trends, such as trends relating to the wearer's health status. The health data can be used to perform diagnostics or to prescribe treatments by doctors or other healthcare professionals working with the wearer, such as for rehabilitation of the wearer. The cloud system may give insights to the wearer in form of a “dashboard” that displays the wearer's actual health, a trend, or progress related to a medical condition. Such a system may also allow doctors who are physically at a remote location to follow health data of the wearer and to analyze the health data on order to prescribe treatments. Diagnostics can be performed using the cloud system with help of adequate algorithms or with analysis supported by artificial intelligence. A first dashboard for the wearer/patient may be configured to provide a clear (e.g. relatively simple) view on health status and trends, and a second dashboard (e.g. containing more information than the first dashboard) for supporting the treating doctors may be enabled by such a cloud system combined with the ISS and additional sensors complementing the ISS.

Thus, the electronics may include computer memory, electronic filters, processors, and communication modules (e.g. transmitters). The electronics are in particular able to measure the impedance via a capacitor compare technique and to drive the potential of an active shield. It may as well receive sensor calibration data from a factory calibration or from an associated mobile phone. During use for example an offset at the start can be calibrated with support from the mobile application in the USER device and be transmitted to the local electronics that contains a memory for the calibration and offset data as well as for the measured data during usage. The connection to a mobile device is not required at all time of the operation.

In embodiments, the ISS is connected to a read out electronics that is placed at a distance (typically in the range of 5 to 45 cm, but can as well be placed in a distance of several to many meters if required by the application scenario) from the ISS and physically connected with electrical wires that may be stretchable or only bendable or fully conformable (even printed) or shielded especially if the length of the cables is long or the surrounding of the cables experiences bigger changes in its (epsilon r) that result in varying coupling capacitances typically in the range of some picofarad (pF) to the range of nano-farads (nF).

This attached electronics device reads out the information and may have a user interface, which in most cases is minimalistic (e.g. a small number of buttons and a set of one or more RGB LEDs or other types of lighted or visual indicators and a haptic (e.g. vibration) feedback device). This electronic device may be wirelessly connected and is, e.g. accessible via mobile device application software that runs, e.g. on a mobile phone, tablet, personal computer (PC) or similar device as well as other embedded devices that act upon the received data. The ISS may be acting as a network of sensors and (with or without other sensors, such as for example, electrodes or SpO2 sensors that measure the saturation percentage of oxygen in the blood) combined with other wearable sensors, in which case the information of several ISS devices is collected by the same mobile device software simultaneously or nearly simultaneously. Several ISS may be physically connected to one read out electronics that reads their data and connects to an associated device that runs a mobile device application software. In most cases the exemplary ISS has in some cases only one sensor impedance, in many cases two areas, each with an impedance, with at least one impedance being sensitive to compression and at least a second impedance being significantly less sensitive to compression, but being sensitive to stretch and external influences. With such a setup the system can distinguish between signal changes that are attributed to changes in the applied pressure (or respective strain in a second embodiment) or to changes that are induced by changes in the environment (parasitic effects) or for example stretch.

A compensation of external influences is possible, as the pressure sensitive and the stretch sensitive capacitance can be both read out by the read out electronics and the signals compared to each other. If a strong correlation among the two sensors can be found, this correlated signal can be used to correct the pressure reading. The signal that is seen in both sensors can be neglected in the measurement results. In case of a pressure measurement, the pressure will typically only influence the pressure sensor, not the reference sensor. The correction may be as easy as a weighted subtraction, but in some embodiments may be a more complex mathematical operation. As both impedances are mainly sensitive to different types of mechanical forces (pressure and stretch), the common signal is assumed to be due to external disturbances that affect both sensors and, as such, the cross-sensitivity can be taken out of the relevant sensor information.

In order to categorize the wording used to classify sensitivity, we consider a sensor being “sensitive to” compression or pressure, if at least 10% of the sensor absolute impedance value changes with an applied compression or pressure force. We further consider a sensor “insensitive to” or “significantly less sensitive to” compression or pressure, where less than 1% of the impedance changes according to the applied compression or pressure force, where the pressure may be applied by a compressive force between, for example, two objects (for example balloons). We consider a sensor being “sensitive to external influences,” if more than 2% of the impedance changes according to external influences. We further consider a sensor “sensitive to stretch,” if at least 10% of the sensor impedance changes with a stretch of the sensor.

Contrary to prior art sensors, the conformable sensor of the ISS embodiments as described herein are conceived with conformable materials that allow for stretch. The sensor is built in several conformable layers that interact with each other. The high stretch-ability in the range of typically 10 to 400% combined with a potentially low stretching force (but made such that the sensor goes back to its initial unstretched form if the outer force applied to the sensor that causes the stretch or compression is relieved) allows, for example in the case of a capacitive sensor that consists of two dimensional stretchable and bendable “plates” (that are very thin: for example less than 100 um) that are separated by a stretchable dielectric layer that may even consist of different materials (see embodiment of the pressure sensor of the ISS), results in an allowance for one plate to bend and stretch, while the plate may simply conform to the curved shape on which one would like to measure. In this case, the dielectric and the electrode that is further away from the object it is applied to, simply stretches, and a pressure that is applied to the sensor system can be measured in the curved (or conformed) shape that is implied by the object it is affixed to. The stretching force of the outer layer is small in such a case and has only a small influence on the overall thickness, and consequently on the capacitive reading of the device. In order to prevent false readings, a reference measurement in the measuring position without applied force can be taken and the pressure readings may then be relative to this reference reading. In a preferred embodiment the dielectric layers in such sensors may have a thickness in the range of 50 to 500 um.

With these characteristics, the ISS may be used between two conformable objects, such as in some applications, between the human body and a garment, or between a soft and a hard object or two hard objects. In the application between two objects, it measures the pressure that is applied from one object to the other object. In the case of a compression shirt, for example, the pressure between the garment and the human body is measured. This is even possible when the shape of the body changes during the measurements, as the soft sensor follows the movement of the body and the implied change of shapes caused by the garment being in contact with the body in different areas.

Applications can be in different areas: in sports shirts or medical patient tracking shirts to measure the pressure exerted by a compression shirt, a shoe insole to measure pressure between the foot and the insole, on the upper shoe material to measure swelling of a foot that occurs during wearing or if a shoe that is not fitting correctly, or to measure pressure between the foot and the upper shoe for the application in the shoe of a race bike to measure the pulling action on the pedals or for a diabetic shoe when the diabetic patient experiences a swelling of his foot.

One application area e.g. is a compression shirt used in sports, where compression is used to exert external pressure on muscle region in order to enhance the force (performance) of the athlete for specific movements or activities. The ISS will, in this particular case, measure the external pressure applied by the shirt to the body, as is described in more detail herein later.

Another application area of the ISS is in robotics, such as, in particular, as a pressure sensitive surface or “robotic skin”. The conformable sensor or sensor system can be attached to or forms the tip of a robotic gripper, where it can measure the gripping force while gripping, as is described in more detail herein later.

The ISS may further be used in gloves as a pressure sensitive user interface, where the force of the finger tips can be measured or their approach to surfaces detected and indicated to the user, thus realizing a user interface/input device, as is described in more detail herein later.

In the field of prosthetics, the ISS may be used to provide tactile information feedback to the user of, for example, arm-/hand- or leg-prosthetics. Additionally, it may be used to provide information about pressure applied from the prosthetic to the human body, as is described in more detail herein later.

In embodiments in which the ISS is fabricated with biocompatible materials, as for example medical grade silicone, the sensor system may be used inside the human body to measure pressure between two objects or between an object and a part of the human body, such as for example when a balloon is inflated inside the body during a surgical procedure or if stretch in a skin or inner layer of the human body requires monitoring of the stretch.

In another configuration, the ISS may be configured as a strain sensor, where one sensor element is implemented as a stretch sensor and a second element may be configured such that it is not significantly sensitive to stretch. To act as a one-dimensional stretch sensor, the “strain sensor” impedance is implemented as a long ribbon, for example with a length of 20-30 cm and for example only 0.5 to 3 cm in width. This configuration is highly sensitive to stretching forces (that lead to elongation of the sensor) along the length of the sensor and barely sensitive to pressure applied on the sensor surface toward the object it is fixed to or applied on. Combined with the intrinsic force of the sensor that works against the mechanical stretch that is low in the length direction compared to the force in the width direction of the impedance sensor structure, the sensor stretches primarily in one direction. This can be pronounced and amplified by the mechanical surrounding of the construction or the construction of the sensor itself.

In one implementation, the sensor is fixed on both ends where a textile (e.g. 1802 in FIGS. 18A and 18B) is integrated into the sensor construction at the edges that allows a strong fixing in these areas (which areas barely stretch, by the nature of the inserted textile). The fixing may be by sewing lines or adequate gluing procedures, the sensor will in this case only be fixed in the foreseen sewing areas (or gluing areas) and the rest of the construction may float over the stretchable object that it is fixed to. This way, a force perpendicular to the length of the sensor cannot influence the sensor elements. This method is in particular of interest if we use a single sensor in the ISS and no second sensor element that allows for corrective algorithms regarding cross sensitivity. A second option is to fix the sensor to, or combine it in, the construction process with a textile as explained before that is stretchable in just one direction and blocks the elongation in the other direction.

This stretch sensor in the variants described before may be further combined with a second element, but not limited to two elements only that is prone to sensitivity in different space directions.

One implementation can be such that at least one impedance is sensitive to stretching force and at least one other impedance is by far less sensitive to stretching force or not stretched by design of the attached fabric or garment, or a pressure sensor that is significantly less sensitive to stretch. Embodiments of the ISS may be used as a stretch sensor in textile garments measuring elongations.

The applications described below additionally have in most cases areas where the ISS can be used in the second configuration as a stretch sensor. Used as smart robotic skin, a local stretch of a robotic arm can be measured, or if placed in a defined position on the skeleton joint, the angles may be measured accurately or a biomechanical analysis of the musculoskeletal health may be derived from analysis of the changes in length in adequate detail.

Exemplary use within a prosthetic is facilitated due to the soft nature of the sensor and its compatibility to textiles. Angular measurements on joints may be performed. Stretch measurements may be used to identify a loose fit of the prosthetic against the human body if the sensors are affixed to the body or a garment worn by the user. In an extended embodiment, the stretch sensor may be accompanied by one or more sets of inertial sensors, referred to wherein as Inertial Measurement Units (IMUs) to measure the absolute orientation in the vicinity of the fixation points to give a second independent information about the joint angles. Therefor the angular information of the IMUs is measured in each point towards the earth coordinates and the relative angle between the two IMUs calculated with algorithms. This system can be used to calibrate the “ribbon” system with the stretch sensor and be combined with an artificial intelligence engine, such that after a learning period, the IMUs may no longer be required.

### Exemplary Technical Implementations

Thus, one object of embodiments of the present invention is to provide a sensor solution for measurements of pressure between two objects of the human body, wherein the sensor solution has a simple and robust construction while allowing accurate determination of the external pressure exerted on a body portion.

Within this description and the drawings, the expression “signal” covers any information, e.g. represented by digital values, as well as physical status values, e.g. electric potentials. Thus, a “signal” within the meaning of this description and the claims may be processed digitally and/or analog.

One aspect of the invention is based on the finding that problems regarding accuracy of determining external pressure when using the electric approach are mainly caused by the fact that signals derived from respective sensors are not only dependent on the external pressure but also on other external influences like temperature, moisture or external electric fields (or mechanical deformations like stretch). When using the ISS according to one aspect of this invention, such external influences may be compensated by making use of the reference signal coming from a reference sensor element, which is affected mainly by the external influences but not significantly by the external pressure. By appropriate calibration of the sensor elements and evaluation algorithms, the external pressure may be derived as a function of the pressure signal derived from the pressure circuitry and the reference signal derived from the reference impedance. On the other hand, the pressure sensor of the ISS according to one aspect of this invention still is an electric sensor, which does not induce complications by integration in between two objects such as for example balloons or between a compression shirt and the human body. Accordingly, the inventive ISS arrangement allows for a simple construction while still ensuring accurate determination of the external pressure applied one object to the other, while an object may as well be for example a conformable T-Shirt or sport pants (pants or long johns) worn as underwear or as a kind of “second skin”. On some cases the use in socks is possible, especially in an application for diabetic patients, where the swelling of the foot may be measured.

The term “impedance” as used in this description and the claims is meant to describe all types of electric circuitries comprising an ohmic resistor, a capacitor and/or an inductor wherein in the pressure circuitry at least one of an ohmic resistor, an inductor and a capacitor have an electric resistance, inductance and/or capacitance which is dependent on the external pressure applied between the two objects.

Within the framework of aspects of this invention, the pressure impedance may be arranged in close proximity to the reference impedance such that the external influences, like external electromagnetic field experienced by both of the pressure circuitry and the reference circuitry, are comparable.

The term “close proximity,” in particular, covers arrangements wherein the spatial distance between the pressure impedance and the reference impedance is equal to or less than the largest extension of the pressure impedance and the sensing impedance, as well as arrangements wherein the pressure impedance and the reference impedance overlap. The two sensors may share common structures, like for example, a ground electrode or a shield electrode.

In an approach to further reduce the impact of external influences on the determination of the pressure between the objects, the pressure impedance and the reference impedance may share common components, which common components experience essentially the same external influences.

In embodiments of the invention the sensing impedance and/or the reference impedance may comprise a resistor and/or an inductor.

In embodiments of the invention, the pressure circuitry may comprise a sensing capacitor having a capacitance which is dependent on the external pressure and/or the reference circuitry may comprise a reference capacitor having a capacitance which is essentially independent from (insensitive to) the external pressure. Use of a sensing capacitor and a reference capacitor enables compact construction while ensuring appropriate accuracy. In some embodiments, the sensing capacitor is essentially composed of an at least partially conductive first electrode layer, an at least partially conductive second electrode layer, which may be arranged essentially parallel to the first conductive layer, and a dielectric layer arranged between the first electrode layer and the second electrode layer. In such embodiments, the sensing capacitor may be realized by providing the dielectric layer between the electrode layers with a compressible sensing portion. When exerting an external pressure on a likewise obtained pressure sensor in the vicinity of the compressible sensing portion, the distance between the electrode layers is reduced to thereby change the capacitance of a capacitor formed by the conductive layers and the sensing portion of the dielectric layer.

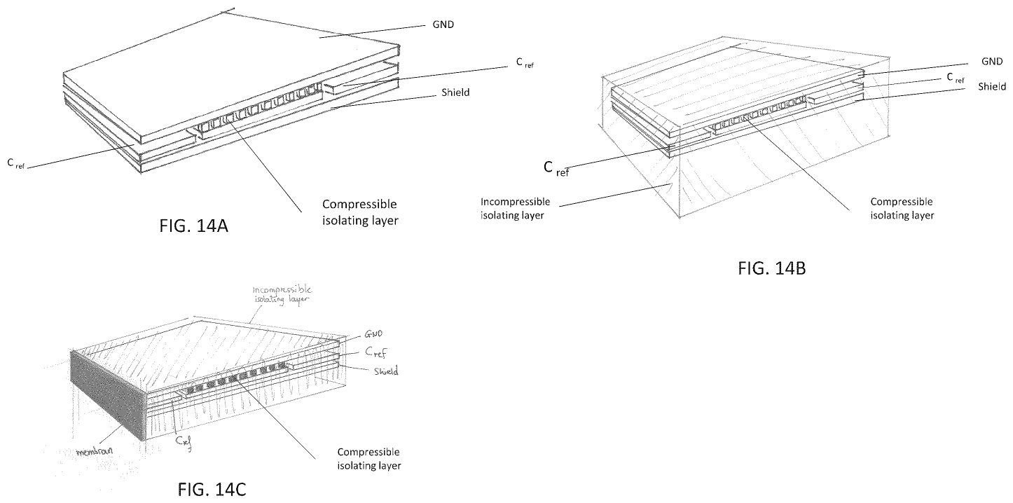

In embodiments, the compressible sensing portion is realized by a mix of an incompressible, but conformable, material and a gas, like air. In one such embodiment, the sensing portion has a closed structure, wherein the gas is contained in a closed cavern (as in FIG. 14B). In another such embodiment, the dielectric may be having a foam structure where within a conformable material gas in trapped in “bubbles” and therefore the structure can be compressed. In another embodiment, the sensing portion has an open structure wherein the gas within the sensing portion is in fluid communication with ambient atmosphere (as in FIG. 14A). In a closed structure, the sensing capacitor may have a capacitance influenced by changes of the inner pressure of the sensor, which may result in a drift signal proportional to a change in the outer air pressure. In the open arrangement, atmospheric pressure influences are not well compensated by the reference capacitor which, as will be explained herein below, may not comprise a compressible dielectric layer.

On the other hand, the open structure may allow water to enter into the gas cavern of the compressible sensing portion. Given that the relative dielectric constant of water is about 80 at room temperature, a wet environment (as is to be expected in the vicinity of a body portion) may corrupt the readings. Thus, the sensing portion of the dielectric layer may be at least partially delimited by a membrane that keeps water out of the compressible sensing portion, but allows for a gas exchange with the environment (as illustrated in FIG. 14C). The dielectric layer may be formed as a foam with air or a compressible gas trapped inside the structure. In this case the sensitivity is prone to changes in the outer air pressure of the surrounded environment and may be compensated by measuring this surrounding pressure with a pressure sensor inside the read-out electronics. In a further approach to adapt the properties of the pressure capacitor, the dielectric constant of the dielectric layer, which may be at least partially composed of silicone, may be modified, as for example to augment the dielectric constant of the silicone layer used as dielectric layer (e.g. loaded or filled with a material that has an intrinsically high Epsilon r). Further, conductive properties of the conductive layers may be adapted as desired.

In general, the conductive layers may also be mainly composed of silicone, which may be filled with conductive particles or nanoparticles, like carbon nanotubes or metal powder (e. g. silver, titanium, copper, aluminum, carbon black, graphene or the like). In order to allow for a variation of the distance between the conductive layers of the sensing capacitors, such conductive layers may have an elongation typically in a range between 50 and 400 percent, and the dielectric layer(s) may have a similar elongation range.

As explained herein above, the pressure circuitry and the reference circuitry may share common components. In embodiments in which the pressure circuitry comprises a pressure capacitor and the reference circuitry comprises a reference capacitor, at least one of the first electrode layer and the second electrode layer may have a conductive electrode area forming the sensing electrode. In such constructions, the sensing capacitor and a conductive reference electrode area are separated from the sensing electrode by an insulating area and form the reference capacitor, wherein the surface area of the sensing electrode facing the potentially common electrode layer may correspond to the surface area of the reference area facing the potentially common electrode layer. “Correspond to” as used herein means that the surface area is essentially the same (e.g. the same, within 1% or less variability). In this case, the sensing capacitor and the reference capacitor may share the other electrode layer as a common component. By adapting the size of the conductive sensing area forming the sensing capacitor to the conductive reference area forming the reference capacitor, the capacitance of the sensing capacitor may be adapted to the capacitance of the reference capacitor, to thereby facilitate compensation of external influences by combining the pressure signal and the reference signal.

As may be taken from the above explanation, the compressible sensing portion of the dielectric layer may be arranged between the sensing area and the opposing area of the respective other electrode layer. The sensing portion may have a columnar structure comprising columns made of a dielectric deformable, but incompressible, material and voids formed between the columns and filled with gas, in particular, ambient air. In embodiments in which mechanical pressure is applied to the columns or pillars of the sensing portions of the dielectric layer, columns or pillars are reduced in height and get wider while still having the same volume. If the dielectric material has elastic properties, it may return to its original shape as soon as the mechanical pressure is reduced or completely eliminated.

In order to make the reference capacitor independent from the external pressure, the dielectric layer may be provided with an essentially incompressible reference portion arranged between the reference area and an opposing area of the respective other electrode layer. In this case, the distance between the reference area and the opposing area of the respective other electrode is kept essentially constant, even when exerting external pressure on the sensor, to thereby leave the reference capacitance essentially unchanged even in embodiments that receive external pressure. The distance between the reference area and the respective other electrode is typically kept smaller than the distance between the sense electrode and the respective other electrode. A preferred distance between the reference electrode and the other electrode is below the distance between the sense electrode and the respective other electrode under the maximum pressure applied to the ISS area, such that the reference area does not limit the pressure range of the sensor in the range that is of interest in the application. In one application segment where small pressure values are to be detected, as for example in between two soft objects (balloons) or for example a sports shirt and the human body. The pressure values in such a case may be between 10 and 120 mmHg. Exemplary pressures of interest may be experienced when the ISS is applied behind a heart rate electrode in a medical shirt to detect if the electrode is conforming to the human body with adequate pressure and if the shirt is worn correctly and in the right size.

For example, ISS embodiments as described herein may be used in conjunction with textile products with an electrical skin contact element as described in US Published application Ser. No. US20190297961A1, titled TEXTILE PRODUCT WITH SKIN-CONTACT ELEMENT AND/OR ESTABLISHING EXTERNAL CONTACT WITH THE SKIN-CONTACT ELEMENT, AND METHOD FOR PRODUCING THE SAME, assigned to the assignee of the present invention and incorporated herein by reference. The foregoing generally describes a textile product comprises at least one electrical skin contact element partially or completely arranged on an inside of the textile product, at least one conductive element in the form of an extensible conductive textile element, the at least one extensible conductive element mounted on an outside of the textile product and in electrical communication with the at least one electrical skin contact element, wherein one of: (a) the textile product has at least one opening, the at least one, electrical skin contact element is adhered to the textile product in a region surrounding said opening or printed on the textile product and is connected to the at least one conductive element adjacent the opening, the electrical skin contact element comprising an extensible electrode having an extensible plastic material comprising conductive particles or graphene; or (b) the textile product has a conductive region comprising a conductive polymer material embedded therein such that the conductive region has electrical conductivity and is capable of conducting a current or a voltage between the inside and the outside of the textile product, the at least one conductive element is connected to the conductive polymer material on the outside of said conductive region, and the at least one electrical skin contact element completely or partially penetrates the fabric of the textile product.

In order to reduce effects of an anisotropic spatial distribution of the external influences, it has been proven advantageous when at least one electrode layer has a central, preferable rectangular or circular sensing (reference) area, and a circumferential or peripheral reference (sensing) area at least partially running around the sensing (reference) area, to thereby at least partially eliminate the effects of the spatial gradient in the external influences differing from the external pressure. In order to reduce the effects of the reference portion on the reduction of the distance between the conductive layers of the sensing capacitor, in a pressure sensor according to one aspect of this invention, the thickness of the reference capacitor in a direction perpendicular to the reference area may differ from the thickness of the sensing capacitor in a direction perpendicular to the sensing area, wherein the reference capacitor preferably is thinner than the sensing capacitor.

In other embodiments of the invention, the sensing impedance, in particular sensing capacitor, and the reference impedance, in particular reference capacitor, are arranged side-by-side.

In a further approach to reduce the influence of external electromagnetic fields on the signals derived from the pressure sensor of the ISS according to this invention, the ISS may further comprise at least one at least partially conductive shielding layer arranged on a side of at least one of the conductive layers. Preferably the conductive layer comprising the sensing electrode and the reference electrode is disposed opposite to the dielectric layer between the conductive layers and separated from the respective conductive layer by a further dielectric layer, wherein means are provided to adapt the electric potential of the shielding layer to that of one electrode layer. Preferably, the electrode layer comprises the sensing area and the reference area. In this way, capacitive coupling of external electric fields to the pressure sensor may be reduced. Within the framework of aspects of this invention, the conductive layer comprising the sensing area and the reference area may be arranged on a side of the dielectric layer opposite to the body portion onto which external pressure should be exerted and/or the conductive shielding layer may be arranged on a side of the conductive layer comprising the sensing area and the reference area opposite to the dielectric layer between those conductive layers.

In a preferred embodiment, the sensor layers are formed such that all electric connections are realized at one side of the ISS, while the shield and ground layers cover most of the sensor interconnect lines that are made out of conductive and conformable materials within the manufacturing process of the active electrode layers that form the sensor areas.

According to aspects of this invention, the sensing capacitor, the reference capacitor and/or the at least one shielding layer may be at least partially embedded in a dielectric embedding arrangement, wherein the dielectric embedding arrangement may comprise a tunnel or gap optionally provided with a gas permeable but water impermeable membrane to allow for pressure compensation between the sensing portion of the dielectric layer and ambient pressure. In this way, the embedding arrangement of the ISS may be formed such that it is essentially water impermeable and/or gas permeable.

According to aspects of this invention, the pressure sensor may be deformable, in particular bendable. In this way it will be possible to adapt the shape of the pressure sensor to the shape of the surface of the object onto which external pressure should be exerted. The desired properties of the pressure sensor may be realized if at least one of the electrode layers, the dielectric layer, the shielding layer and the embedding arrangement is at least partially composed of conformable material, in particular comprising silicone, as discussed herein before.

The pressure sensor may be connected to a supply device preferably via low ohmic wiring. In embodiments with conductive wiring, in particular low ohmic wiring, this may be electrically connected to at least one of the electrode layers with a via soft conductive glue, in particular silicone glue.

In order to reduce the influence of movement of the body portion on the result of determining external pressure, the wiring may be at least partially stretchable or conformable. To further improve the signal integrity of the wires, a shielded wiring solution may be used to avoid the effect of external influences on the wires.

According to aspects of this invention, capacitances of the sensing capacitor and the reference capacitor may be determined by a capacitor compare technique. This technique may be implemented by providing a supply device which is capable of charging the sensing capacitor and/or the reference capacitor and discharging the sensing capacitor and/or the reference capacitor to a collecting capacitor having a predetermined fixed capacitance that preferably exceeds the capacitance of the sensing capacitor and/or the reference capacitor. The number of charges required to charge a larger reference capacitor by transferring the charges of the sensing capacitor is counted. This number of charges then may give direct feedback to the value of the sensing capacitor. By processing this number of charges, the external pressure may be computed, as it may be linearly depending on the number of charges measured.

In determining the external pressure in embodiments of the invention, it may be assumed that external influences induce a constant offset for the first and second number of charge and discharge cycles. When a predetermined number of charge and discharge cycles for the reference capacitor is determined under reference conditions and calibration of the sensing capacitor is effected under the same reference conditions, the difference between the predetermined number and the second number of charge and discharge cycles presents a constant offset. This constant offset may be subtracted from the first number of charge and discharge cycles to thereby obtain a number of charge and discharge cycles for the sensing capacitor, which is only dependent on the external pressure as an input for determining the external pressure based on a calibration curve or function obtained under reference conditions.

In other embodiments it may be assumed that the offset of the first number is determined by the offset of the reference measurement obtained by the reference capacitor. The functional relationship may be further linear, quadratic or cubic.

The pressure sensor of one inventive arrangement for pressure- or strain measurement may be linked to a transmitter operable to transmit signals to an external device, wherein such signals may comprise user information obtained by algorithmic treatment of the obtained signals corresponding to the external pressure. The external device may have a processor operable to process the obtained signals from the ISS in order to obtain valuable information for the respective application, for example information for coaches or the wearer of the sports shirt on fit and function or to control a gripping process in case of a robotic hand. The inventive arrangement may further comprise a converter, e.g. a display or speaker, linked to the processor and operable to generate a perceptible signal corresponding to the external pressure, e.g. a visual and/or audible representation and/or a vibrational representation of the external pressure. Further, computer memory may be provided and configured to store pressure data corresponding to a plurality of external pressure values.

An input, such as a user interface, may be linked to the processor, which input may be operable to input external data, e. g. user data, device data, target data, etc. Embodiments of the inventive ISS or the associated electronics device may further comprise at least one temperature sensor, at least one moisture sensor, at least one bio-impedance sensor or an electrode to sense electric field of the human body (e.g. heart rate) and at least one movement sensor, at least one acceleration sensor and/or at least one position sensor and/or at least one (ambient) air pressure sensor.

In an exemplary method for operating an arrangement according to aspects of this invention, an external pressure is determined on the basis of a cumulative signal dependent on the external pressure and other external influences acting in the vicinity of the sensing impedance, and a reference signal independent from the external pressure, but dependent on other external influences acting in the vicinity of the reference impedance, which external pressure may be monitored within the framework of applications for the ISS.

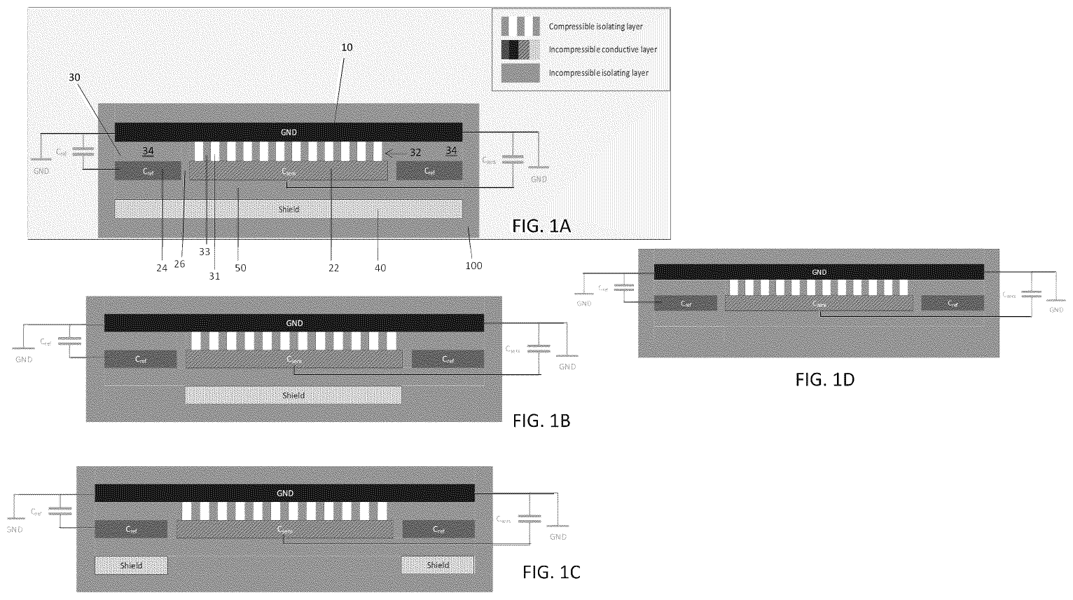

The pressure sensor shown in FIG. 1A comprises a first conductive layer 10, a second conductive layer 22, a dielectric layer 30+31+32, disposed between the first conductive layer 10 and the second and third conductive layer 22 and 24, and a conductive shielding layer 40 disposed on a side of the second conductive layer opposed to the dielectric layer 30 and separated from the second conductive layer by a further dielectric layer 50. The first conductive layer 10, the second and third conductive layer 22 and 24, the dielectric layer 30, the shielding layer 40 and the second dielectric layer 50 may be, as a whole, embedded in a dielectric material 100.

The first conductive layer, the second and third conductive layer and the shielding layer extend in parallel planes. The term “parallel planes” as used herein is intended to include any planar arrangement that one of skill in the art would consider to be “essentially parallel,” such as parallel within one degree of difference in angle relative to a line perpendicular of one of the two planes. The second and third conductive layer 22 and 24 comprises a central sensing area 22 (second conductive layer) and a circumferential reference area 24 (third conductive layer), running at least partially around the sensing area 22 and separated from the sensing area 22 by an insulating area 26. The dielectric layer 30 comprises a compressible sensing portion 32 and an incompressible reference portion 34, wherein the compressible sensing portion 32 is disposed between the sensing area 22 and the first dielectric layer 10 and the incompressible reference portion 34 is disposed between the reference area 24 and the first conductive layer 10. While the second conductive layers 22 has a smaller distance to the ground layer 10 than the third conductive layer 24 whilst the difference in height is absorbed by the isolating layer 50 or simply leads to a height difference of the ISS in this region.

The compressible sensing portion 32 of the dielectric layer 30 comprises a pillar or columnar structure formed by pillars 33 separated by air-filled voids 31. Each pillar may have a circular cross section having a diameter of 5 mm or less and/or 1 mm or more, in particular about 2 mm, and a height of 1 mm or less and/or 0.1 mm or more, in particular about 0.3 mm. The height of the pillar may be smaller than the diameter thereof. When exerting an external pressure on the pressure sensor shown in FIG. 1A in a direction perpendicular to the conductive layers 10 and 22 and 24, pillars 33 are compressed and widened in a direction parallel to the conductive layers 10 and 22 to thereby fill part of the volume previously occupied by ambient air between the pillars. In this way, the capacitance of the sensing capacitor formed by the first conductive layer, the sensing area 22 as second conductive layer and the sensing portion of the dielectric layer 30 is modified. On the other hand, the external pressure exerted on the sensor does not substantially affect the capacitance of a reference capacitor formed by the first dielectric layer 10, the circumferential portion 24 the third conductive layer and the incompressible reference portion 34 of the dielectric layer 30. External influences of external electromagnetic fields are shielded by shielding layer 40 held on the same electric potential as the second conductive layer 22 or as respective the third conductive layer 24 depending on which measurement is performed.

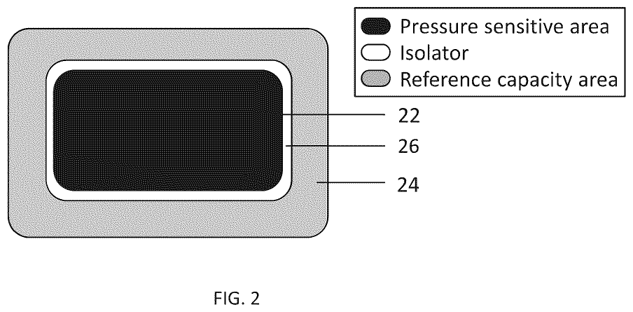

An exemplary structure of the second conductive layer 22 and the third conductive layer 24 is illustrated in more detail in FIG. 2. It comprises a central, rectangular portion 22 and a circumferential portion 24 running around the central portion 22, which circumferential portion 24 is separated from the central portion 22 by insulating material 26. By “rectangular” it should be understood that slight variations from a perfect rectangle (i.e. “essentially rectangular”) may be included within the meaning of this term, and, for example, the vertices may have a radius, and the angles of the vertices may vary from a perfect 90 degree angle by a minimal amount (e.g. less than 1 degree).

All layers of the pressure sensor embodiment shown in FIG. 1A may be formed by silicone, which is partially filled with conductive material in the vicinity of the first conductive layer 10, the second and third conductive layer 22 and 24 and the shielding layer 40. The thickness of conductive layers may be selected to be within the range between 10 μm and 400 μm, in particular 10 to 70 μm. The silicone may have an elongation at break of between 100 and 250 percent. The thickness of the sensor may be within the range of 0.2 to 5 mm, in particular 0.5 to 2 mm.

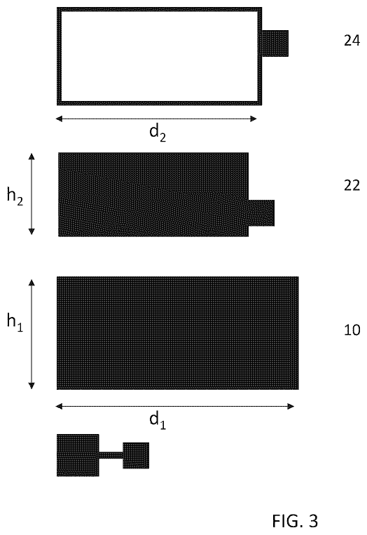

In the exemplary embodiment depicted in FIG. 3, the conductive portion of conductive layer 10 may have a width d₁ of about 64 mm and a height h₁ of about 31 mm. The sensing area 22 may have a width d₂ of about 61 mm and a height h₂ of about 28 mm. The conductive area encircling the sensing area 22 may have an outer width of about 63.7 mm and an outer height of about 30.4 mm. The invention is not limited to structures having any particular dimensions, however.

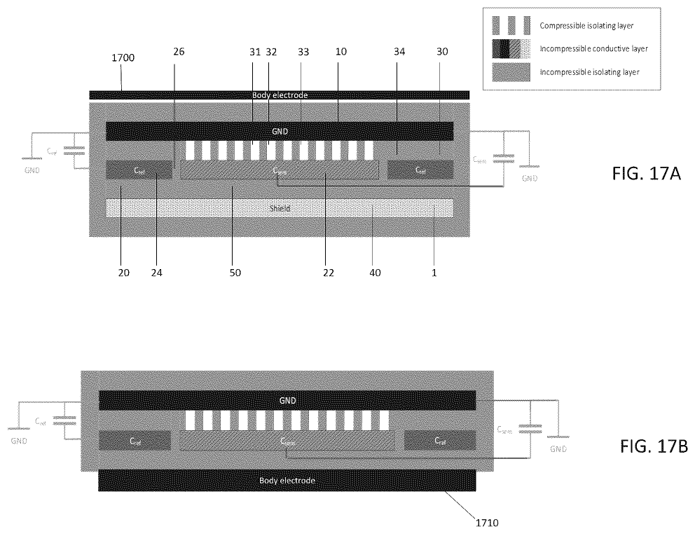

In a further exemplary embodiment of the ISS as described in FIG. 1A, shown in FIG. 17A, the sensor contains an additional conductive layer (body electrode 1700) above the ground or shield electrode. This layer is not insulated and may be used an electrode contacting the human body. In contact with the human body, the sensor electrode senses the electrical field generated by the human, and if we combine two such sensors, an ECG can be measured. At the same time the pressure with which the electrode is pressed against the human body can be measured. By help of this measurement the right fit of the heart rate sensor assembly may be derived and in use a good visibility on the correct contact of the electrode to the human body can be measured. The assembly may contain more sensors, in particular five of these sensors to use them in a specific arrangement around the upper body (as is known in the art), such that with the signals form the five electrodes, a full 12-channel ECG can be constructed, by the signals in combination with an algorithmic data treatment that is performed in a remote mobile unit. An arrangement with a body electrode may also be realized with a shield electrode 1710 that is not insulated, as depicted in FIG. 17B. The ground and the shield electrode may be simply exchanged by electric means in the read out electronics to realize this function.

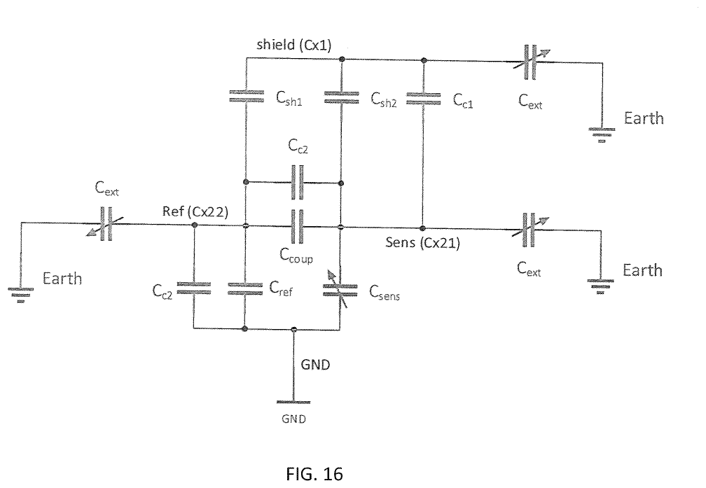

For determining the pressure-dependent capacitance of the sensing capacitor (Cx21), this sensing capacitor is charged via an electrical connection to the read out electronics in the equivalent circuit diagram of FIG. 16 and discharged to a collecting capacitor (not shown) that had been discharged before the measurement cycle starts. This charge/discharge cycle is repeated until a predetermined potential of the collecting capacitor is detected. The number of charge and discharge cycles needed presents a cumulative signal within the context of this description and the claims and is stored as a first number. In determining the capacitance of the reference capacitor C_{ref} in the equivalent circuit diagram of FIG. 16, the reference capacitor is charged via input Ref (Cx22) in FIG. 16 and discharged to a collecting capacitor after this collecting capacitor has been completely discharged. This charge and discharge cycle is repeated until the collecting capacitor is charged to a predetermined potential. The number of charge and discharge cycles needed to load the collecting capacitor via the reference capacitor presents a reference signal within the context of this information and the claims and is stored as second number. This second number is compared to a reference number obtained by charging and discharging the reference capacitor under reference conditions until the collecting capacitor reaches the predetermined electric potential. The difference between the second number and the reference number is subtracted from the first number to thereby obtain an input number for determining the pressure based on a predetermined calibration curve obtained for the sensing capacitor Cₛₑₙₛ. The parasitic elements present within the ISS make the comparison more complex and the relationships might not be strictly linear or simply proportional which may be compensated by and adequate read out algorithm.

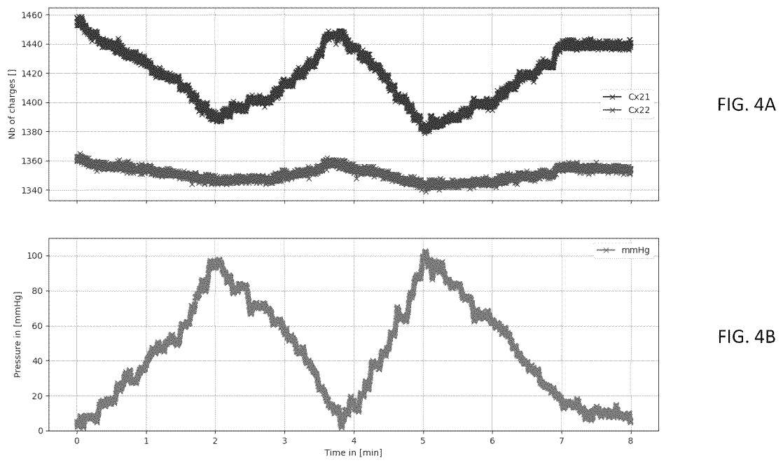

FIGS. 4A and 4B illustrates how an external pressure is determined by making use of the ISS arrangement to measure the pressure between two objects (conformable objects, partially conformable objects or non-conformable objects). FIG. 4A shows how the number of charge and discharge cycles presenting cumulative signal changes when increasing and decreasing external pressure within the range of from 20 to 100 mmHg in the upper graph. FIG. 4B illustrates absolute pressure values obtained by using the difference between the cumulative signal and the reference signal shown in FIG. 4A as an input for a predetermined calibration curve. FIG. 4B illustrates that it is indeed possible to calculate from the first number of charge-discharge cycles (cumulative signal) and the second number of charge-discharge cycles (reference signal) absolute pressure values with high accuracy.

According to this invention the pressure sensor as schematically illustrated in FIGS. 1A-3 may be attached to a first object such that the first electrode layer faces the inner portion of the object (for example a balloon filled with a liquid) to which an external pressure should be exerted and the external pressure is exerted onto that object portion via shielding layer, the second conductive layer, the electric layer and the first conductive layer.

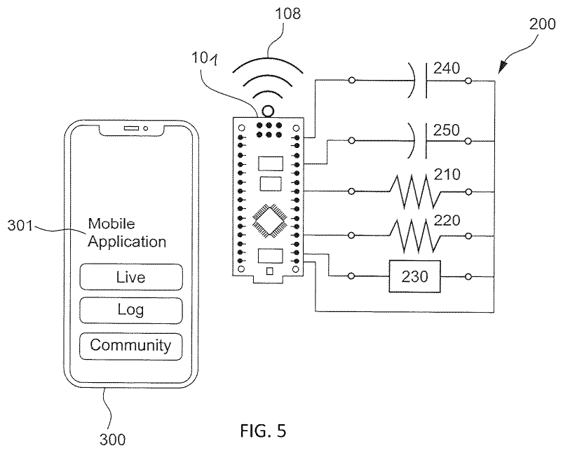

FIG. 5 illustrates the sensor device 200 and the transmitter means 100 linked to the sensor device and to an external device 300, such as a mobile communication device, which may be realized by a smartphone and usable as graphic user interface for the application that uses the measured pressure between 2 objects (as for example 2 soft objects as balloons or a robot hand with a sensor glove or a shirt worn in sport or daily life. The sensor device 200 of FIG. 5 may exemplarily comprise one or more resistive sensors 210, 220 and/or one or more sensors 230 which are mainly based on additional or other physical processes such as capacitive sensors, each linked by wire to the transmitter means and one or more capacitive pressure sensor 240 and one or more capacitive stretch sensor 250, also linked by wire to the transmitter means 100. For example, sensor 210 may be a temperature sensor, sensor 220 may be a moisture sensor, and sensor 230 may be an electrode arrangement gathering signals from the human body, a movement sensor, an acceleration sensor or a position sensor.

Further to comprising transmitting elements, transmitter means 100 may comprise additional circuitry for deriving temperature and/or pressures signals from sensor device 200, e.g. inductive elements and frequency analyzer elements for deriving pressure value from pressure dependent values, such as capacity values of capacitors 240 and 250.

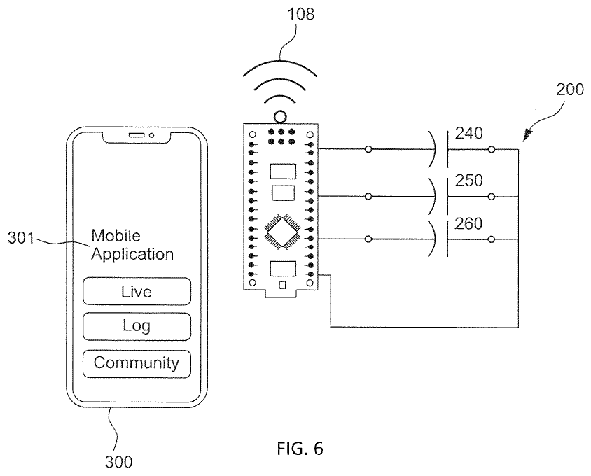

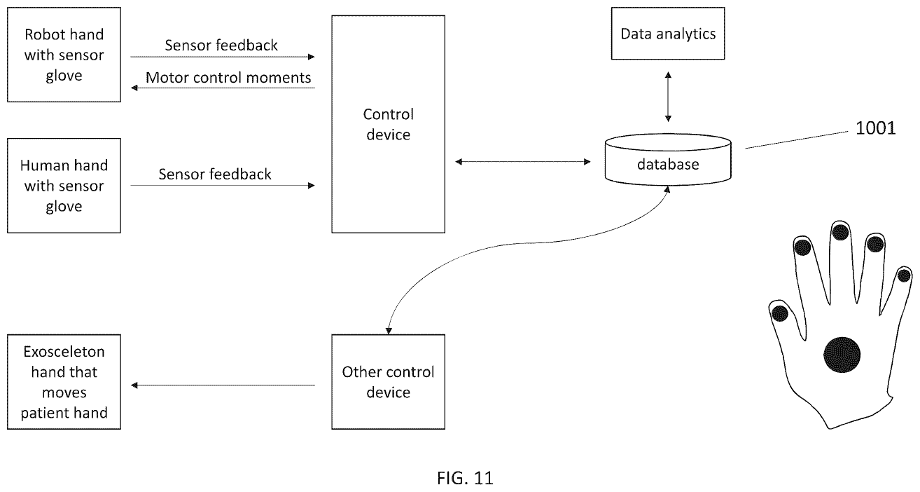

As shown in FIG. 6 the external device 300 comprises converter means realized by a display which display may also be used as input means for inputting user data and user commands. The external device 300 may also be used as a web client communicating with an external entity, such as third-party component (not shown) that may be a server, web interface and/or another mobile application, or such as database 1001 of FIG. 11. The external device 300 may have installed thereon an application 301, such as a mobile application (app), which is capable to generating an indicator, such as indicator in FIG. 4, providing a graphic representation of pressure-related data, such as in form of one or more graphs illustrating development of current pressure and/or temperature level (not represented).

The embodiment shown in FIG. 6 mainly differs from the embodiment illustrated in FIG. 5 in that it comprises a sensor device 200 having three ISS visualized as capacitive impedances 240, 250 and 260, each linked by wire to transmitter means 101.

According to FIG. 6 temperature sensor 210 (not shown) and three highly flexible pressure sensors 240, 250, 260 are attached to or integrated into a compression garment or bandage. Temperature and pressure signals are transmitted via transmitter means to external device 300 which is capable of storing a plurality of temperature and/or pressure data and generating a graphic representation of pressure data and external data as a graph illustrating development of pressure levels 140, 150, 160 and/or temperature level 130.

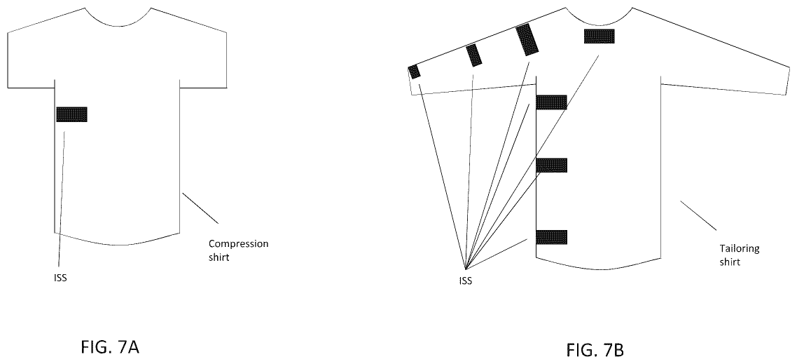

FIG. 7A shows a possible application of the ISS in a sports compression garment (e.g. a shirt), where the compression exerted by the textile on the wearer can be measured in a defined position. In this way, the measurements allow a determination of whether the shirt provides the right compression at the right position. Extending the number of sensors, as depicted in FIG. 7B, allows adaptation of the pattern of the garment according to the user, which enables individually tailored textiles without the need for circumference measurements, which are often error prone due to the lack of a general definition of the measurement position. This may facilitate custom-cut online platforms providing custom-cut textiles to the user or may permit users to simply choose the right textile size for the user from “off-the shelf” sizes.

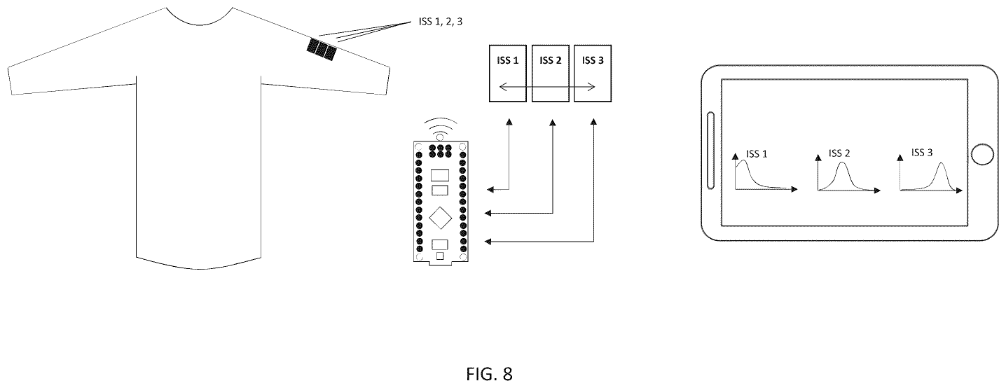

FIG. 8 shows a possible application scenario of multiple ISS mounted on a sleeve such that a pressure sensitive swipe interface can be realized. The ISS might be used in this case as a user interface to the shirt electronics which could control other connected devices, such as smartphones.

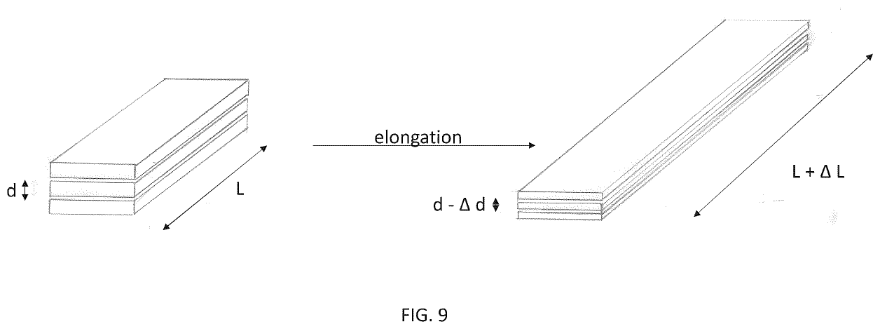

The strain sensor impedance of the ISS comprises two conductive surfaces (electrodes), which are oriented in parallel being separated by incompressible dielectric layer. This dielectric may be formed of an incompressible material (as for example silicone). The working principle is shown in FIG. 9. If the sensing system of such construction is stretched (L+ΔL) the dielectric layer preserves its volume and extends in the x or y direction while getting thinner in the z-direction. The distance among the two conductive surfaces is reduced (d−Δd) and the capacity of the structure is getting bigger. As the dielectric is incompressible, the distance among the two electrodes is not or barely changed by the application of pressure on the sensor. This way, the stretch sensor provides the ideal reference sensor for the compression sensor. And furthermore, as the compression sensor is not or barely changing its impedance by elongation, the pressure impedance is an ideal reference sensor for the elongation sensor.

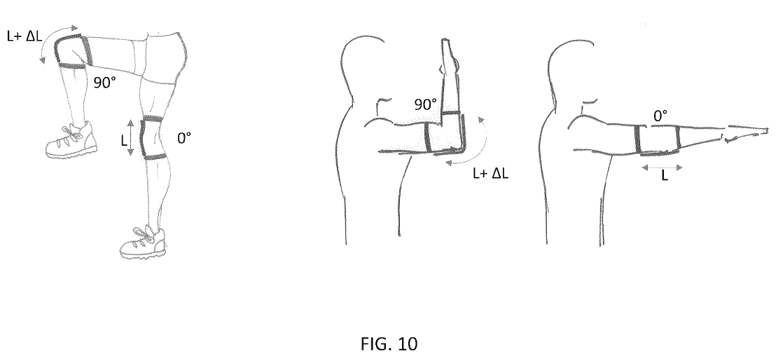

The conformable stretch sensor has a multitude of applications in the field of textile sensors.
1. The stretch sensor may be affixed to a sports shirt (e.g. as shown in FIGS. 7A and 7B) such that the breathing rate can be measured through the elongation of the sensor due to the inflation of the lungs. Implementing a plurality of those sensors in such a shirt, the breathing volume may be estimated without measuring the airflow directly. A wearable sensor system capable of simultaneously measuring respiration rate and estimating the breathing volume may be realized in the form a sensor garment.
2. The stretch sensor may, e.g., be attached around a muscle or a limb, in order to measure muscular activity or swelling. This application may be used to analyze musculoskeletal health of a person.
3. The stretch sensor may be applied on a person's joints to measure the joint angles FIG. 10. This application may be especially useful in rehabilitation, such as for measuring joint angles in a home environment for creating a record of the effectiveness of exercises performed.
4. One application includes a sensor shirt (e.g. as shown in FIGS. 7A and 7B) that measures the circumference of the upper body limbs, as well as the torso, such that custom cut textiles may be fabricated. In this uses case, the client will not need to go to an alteration tailor to do a perfect adaption of the shirt. This method will apply to sports trousers as well.
5. The sensor system applied to a sensor shirt (e.g. as shown in FIGS. 7A and 7B) may as well be used to detect breathing motion, several stretch sensors can be placed on the textile to measure the breathing motion of the stomach, the chest and the change in distance between the chest and the stomach. The shirt may in this case be affixed to the pants of the wearer or equipped with a belt structure to keep the textile in place allowing for a precise measurement and preventing that the shirts moves up due to breathing motion or excessive movements of the wearer.

FIG. 11 shows the application of the ISS in an artificial skin scenario. The ISS is in this use case applied on a glove at the fingertips and on the inner hand enabling measurement of the compression of a grasp. This enables a training scenario of a human grasping, for example, a non-boiled egg, which can then be mapped to a robot hand grasping a non-boiled egg as well. The ISS sensor glove may then be used on the robot hand identically to the human hand to sense the applied pressure on the egg. The obtained data of the grasping can then further be exploited to train a patient's hand grasping a non-boiled egg through the use of an exoskeleton hand. This last usage scenario may be useful in rehabilitation (e.g. after a stroke or an injury) in order to get back the full functionality of a person's hand. FIG. 11 shows as well the data flow with respect to the control signals and the interaction between the involved electronics devices.

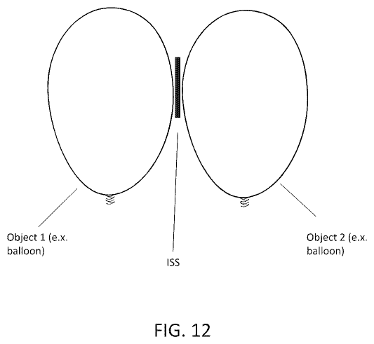

FIG. 12 shows how the sensor can be applied between two balloons to measure the pressure between them. As this requires a conformable sensor, the ISS is ideal for usage scenarios with analogous forces applied between conformable objects that can be modeled or approximated by balloons.

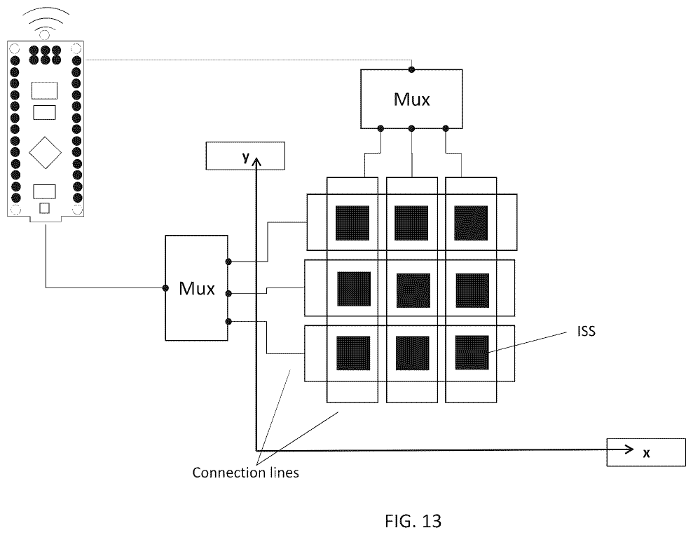

FIG. 13 shows a matrix scenario of the ISS. In the figure, the matrix consists of three by three ISS sensors, which are sampled one by one in a consecutive manner. This way, a x-y-resolution of the ISS can be achieved by just consuming two sensor inputs, which are switched through the three sensors in x and y. This enables the use of a large amount of ISS by just a small amount of sensor inputs and it further simplifies the wiring of the sensor grid, as the matrix structure only needs to be connected from the outside. This usage scenario is especially advantageous for the artificial skin as described with reference to FIG. 11. Using this matrix structure, the sensor glove with dedicated sensor positions may be changed to a sensor glove that allows sensing the pressure on any position of the glove.

FIGS. 14A-C show, respectively, an open structure, a closed structure, and a structure with a membrane. The open structure would be vulnerable to water as its high epsilon-r will highly raise the sensor capacity. The closed structure will be influenced by atmospheric pressure changes. The structure with a membrane will prevent having some water entering the structure, while a gas exchange to the exterior is possible.

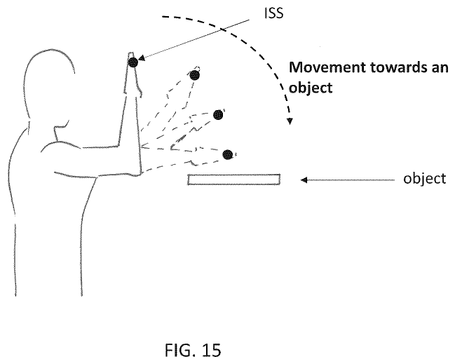

FIG. 15 shows the ISS configured as shown in FIG. 1B such that the pressure impedance of the ISS changes with the approximation of an object as well as with the pressure. This allows to measure the approximation in a short range (1-5 cm) above the sensor, before the sensor is being pressed. This is especially useful in the field of robotics, where usually different sensor information is used to measure the proximity to an object and further the force applied to an object. The ISS would make it possible to have both measures combined. Especially, if the robot is moving fast, having an early detection of a close object is very important, as this would make it possible significantly reduce the speed of the robot motion before hitting an object. Therefore, this could be even used to provide a secure joint work of human beings with industrial robots.

### EXEMPLARY APPLICATIONS

Pressure Measurement Between Two Objects

The ISS is ideal for measurement of pressure between 2 conformable objects and may work well where only one object is conformable and even in some applications in which both objects are not conformable. As an example, the measurement of pressure between two objects in form of balloons (or, for example, a ball with an inner hull) can be performed. The balloons would not be impacted by the nature of the sensor as it is entirely soft and conformable.

Many further application examples are possible and the invention is not limited to any particular applications for use of the sensor.

Compression Shirts or Garments

In a compression application on the human body, it has been proposed to incorporate into the compression shirt a pressure sensor which is capable of producing at least one pressure signal indicative of the external pressure and transmitting pressure signals to an external device via appropriate transmitter means, or to transmitting fitting information to the user, trainer or tailor. This enables the wearer and his trainer or tailor to monitor the correct fit. In performance sports, compression garments can improve the muscular strength of the athlete. This may work if the compression is adjusted to the correct values an in the right position. The ISS may provide valuable measurements of the applied compression during sportive activity, not only in a lab setting.

### Wound Dressing

The ISS may be used in the application of wound dressing in order to assure that the wound dressing is not applied so tight that it may prevent blood flow or circulation of fluids in the body.

### Application in Robotics or Prosthetics as “Sensor Skin” or Artificial Skin

Within the application area of robotics or prosthetics the ISS is of particular interest as a pressure sensitive surface or “robotic skin”. The conformable sensor or sensor system may be attached to or form the tip of a robotic gripper. There it can measure the gripping force while gripping. With the adequate feedback loop the gripping force can be effectively controlled and the interaction with the environment made highly precise. Due to the nature of the soft and conformable materials, the surface of the sensor can be slightly sticky (rubber like/silicone), such that a good grip can be obtained and such that there is no slipping of the object through the fingers. The application of the ISS is in particular of interest in applications where sensitive objects (for example an egg) need to be handled by the machine. The ISS with its physical characteristics and the pressure measurement in combination with a feedback loop allows robots to interact with their surroundings with a higher precision.

With some changes in the layer structure, the ISS may be enhanced to give the robot the ability to detect an approaching object as for example a human body (arms, body, head, fingers . . . ) or other objects (as for example metal objects) with a significant ∈ᵣ. For example, water has a relatively high ∈ᵣ of 80, as compared to air having an ∈ᵣ of 1, or silicone, which as a typical ∈ᵣ of approximately 3 (if not significantly modified).

In the case where proximity of objects is of use in the application, the ISS senses changes in the impedance induced by external fields of approaching objects (capacitive coupling) as they are induced by objects with a high ∈ᵣ to a conductive area right under the insulating surface layer of the ISS.

The contact and force after touching can be measured. Arranging the ISS in a matrix structure comprising a plurality of ISS sensors allows for locating the point of contact, as well as determining the direction of the approach of a high ∈ᵣ object.

The ISS sensor technology gives the geometric freedom to conceive a matrix structure providing positional information in 3 dimensions (x, y through a matrix structure of pressure sensitive impedances and z through the approximation sensing before touch and the depth of the contact after contact (in touch) This way the ISS may be used, but is not limited to, artificial skin in the field of robotics or as a pressure sensitive user interface.

The use of the ISS in prosthetics allows for better interaction and feedback to the wearer of the prosthetics. As for example a mechanical gripper can be equipped with the ISS and a feedback to the wearer can be given by the associated electronics in various forms, for example vibration, sound, light or as an electrical pulse or stimulus to the skin or a nerve or a muscle of the wearer. In a prosthetic leg, the feedback on ground contact or contact with a “hurdle” could be signaled. If the matrix approach is used, the ground contact of contact to the human body could be analyzed in more detail.

### Tactile User Interface for Garments and Gloves

The ISS may further be used in gloves as a pressure sensitive user interface where the force of the finger tips can be measured or their approach to surfaces detected. The touching and the touching force could be implemented as feedback to the User, as well as interpreted as a control signal for the functions of an associated e-textile (wired or wireless) sent to a remote electrical device as a command. Such gloves could be used as simple user input device or give feedback to the user within a sensitive manufacturing operation or for a more detailed analysis of the manufacturing process steps. For blind people as a touch interface signaling approaching objects in case of a high Epsilon r of these objects.

The ISS may be directly integrated into a smart jacket or similar e-textiles as a conformable user interface that reacts on approximation, on touch and that is pressure sensitive. This user interface may be especially useful in garments, as the ISS is soft and machine washable. It can be used as smart user interface to control smart devices such as smart watches or smart phones or functions of the e-textile like for example lights or heating features. Compared to typical force sensing technologies, the ISS provides a high performing tactile interface: it senses approaching objects that have a high (Epsilon r), realizes a touch and measures applied forces applied to the sensitive area.

### Use in a Diabetic Shoe or Sock

Diabetic patients may encounter problems with swelling feet. Detecting this swelling is of advantage, as a diabetic shock may follow and may be prevented. Further on, the swelling can lead to ulcers and these may be difficult to cure.

The ISS may be configured in one implementation as a pressure sensor and put into the sole or the upper shoe. If the ISS is integrated into the shoe sole in a matrix configuration, the areas that are seeing the pressure from the users' feet can be can be mapped. This area will change such that the area where pressure is increased in getting bigger with the swelling. and with the analysis of the area, the swelling can be detected. The implementation of the ISS on the inside of the shoe upper can detect changes in the applied pressure from the upper to the shoe. If this is compared to the to the normal applied pressure it detects if the average pressure increases over time and can signal this via the associated electronics to the user.

In the configuration where the ISS may work as a stretch sensor, it may be associated (glued or integrated or attached) to a sock in the area around the mid foot. The measurement in this case is the circumference of the foot. A changing circumference will indicate a swelling of the foot and the associated electronics may either warn the user directly or send the information to the associated remote devices with a wireless transfer protocol.

### Pressure Measurement Inside the Human Body

In embodiments in which a biocompatible material is used for the construction of the ISS, for example biocompatible silicone and biocompatible electrical wiring, the sensor may be implanted in the human body to measure forces exerted as pressure in certain body areas or in the form of a stretch sensor to detect stretch, for example of tissue or a bladder inside human body.

During surgical procedures, pressure measurements at the top of a tip or inside an artery may be required, or the pressure introduced by inflations.

A sensor may even be affixed to a tendon to detect stress or elongation.

### TECHNICAL SUMMARY OF THE INVENTION

The ISS opens up possibilities for different application scenarios and addresses known technical challenges with an approach of combining two impedances that are implemented with soft and stretchable materials and that put into value their fundamental difference in their reaction to the same external physical influences and that may have a sensitivity to a second external physical influence. External influences or a “stimulus” may be as example pressure, stretching force or electrical field. In the following section, technical aspects are described with some more detail.

In the easiest form, the ISS may be a single conformable sensor to measure pressure or stretch. In a slightly modified arrangement the ISS is a single sensor that is shielded against influence from external electromagnetic fields that may falsify the reading.

The ISS in arrangement where more than one measurement impedances are used, the arrangement allows to compensate for external influences, which might disturb the measurement of the applied pressure in the described application scenarios, all while having a soft and conformable structure where all materials used in the main sensor area are conformable. Only the wiring that connects to the sensor at a specific area may be realized with metallic threads or similar electrical conductors, but may as well be of a conformable nature.

In a further configuration of the ISS, it comprises at least one sensing impedance, which is sensitive on the external pressure and at least one other impedance, which is significantly less sensitive to external pressure and both impedances are sensitive to external electric fields or stretch, wherein a cumulative signal which is dependent on the external pressure and other external influences in the vicinity of the sensing impedance is derivable from the pressure sensitive impedance and the other impedance. The second impedance of the ISS may be considered a reference Sensor.

An active shield in form of an additional electrode layer (conductive layer) may be used to keep the influence of external electric fields away from the inner sensor structure. Therefore, the active shield electrode may be on the opposite side of the ground electrode, while the ground electrode may be common to the first and the second impedance in the ISS. An electrical potential is applied (or driven onto) the shield layer while reading out the sensor information. The electrical potential that is applied corresponds closely to the potential of the sensor electrode that is read out. The sensor electrode(s) is separated from the shield electrode by an insulation layer. The sensor electrode and the shield electrode may be held on the same potential and fed out of the same reference potential, making the potential on these electrodes essentially the same, with variations due to the physical size and the timely distribution of the potential over the respective surface areas. Therefore, it can be assumed that the electrical potential on the sensitive electrode as well as on the shield electrode are the same (with slight differences as described above), therefor the capacity among those two electrodes does not play a role and is close to zero. By construction, the active shield allows to shield the sensor electrodes that are situated between the shield electrode and the ground electrode (e.g. as depicted in FIG. 1A). The shield electrode and the ground electrode englobe the sensor electrode areas. In this construction the sensors are shielded against influence from external electromagnetic fields. The ISS may use the active shield layer to either prevent being sensitive to changes of ∈ᵣ in the near field of the sensor, or to being sensitive to significant changes in the surrounding electrical fields, as for example when a human hand approaches. In embodiments in which the shield electrode is used to measure the changes in the external fields in the vicinity of the ISS, an approaching object that has a high ∈ᵣ can be detected and this effect can be used. In such applications, the device may be considered a capacitive proximity sensor.

Compression sensitivity: The pressure sensitive impedance is essentially composed of an at least a partially conductive first electrode layer, an at least partially conductive second electrode layer, which may be arranged essentially parallel to the first conductive layer, and a dielectric layer arranged between the first electrode layer and the second electrode layer, the sensing capacitor may be realized by providing the dielectric layer between the electrode layers with a compressible medium. When exerting an external pressure on a likewise obtained pressure sensor in the vicinity of the compressible medium, the distance between the electrode layers is reduced. The change in distance between the electrodes leads to a change of the capacitance of a capacitor formed by the conductive layers and the compressible medium of the dielectric layer.

In one implementation of the ISS, the compressibility of the sensing portion of the first impedance is obtained by composing the dielectric layer by a mix of air or another gas and a deformable material like silicone, which is not compressible but conformable, the change of capacitance is also affected by the (partial) replacement of air in the sensing portion by the conformable dielectric material. This can be explained by the fact that a conformable material, like silicone, generally has a relative dielectric constant ∈ᵣ, which differs from the dielectric constant of a gas, like air, having a relative dielectric constant ∈ᵣ=1.

Stretch sensitivity: The stretch sensitive impedance is essentially composed of an at least partially conductive first electrode layer, an at least partially conductive second electrode layer, which may be arranged essentially parallel to the first conductive layer, and a dielectric layer arranged between the first electrode layer and the second electrode layer. The sensing capacitor may be realized by providing the dielectric layer between the electrode layers with an incompressible but conformable medium. When exerting an external stretching force, the incompressible medium will stretch and keep it overall volume constant which leads to an increase in size (lateral dimensions) and a decrease in the distance between the two conductive layers such that the capacity will increase as well as the electrode resistance does.

Sensor matrix or array: The ISS may be extended to a sensor matrix consisting of multiple ISS attached to each other. The ISS may be physically attached to each other and be connected electrically to a common signal processor for monitoring and interpreting the signals. This matrix structure allows to give the tactile information an additional spatial information. This way the tactile information may also be localized.

Controlled adaptive sensitivity to external fields: Depending on the application, the ISS may be made either sensitive to external fields, or insensitive to external fields. As the ISS consists of at least two impedances, both can be either made sensitive to external influences or not. This allows to produce different versions of the ISS:

Completely shielded ISS as shown in FIG. 1A: In this embodiment, the active shield is applied above the pressure and the stretch sensitive impedance. In this case both impedances are not sensitive to external changes in the near field. As a consequence, the sensor system will be robust to external influences and just measure pressure and stretch.

Shielded pressure impedance as shown in FIG. 1B: In this embodiment, which is otherwise identical to the embodiment depicted in FIG. 1A, the active shield is applied just on the pressure impedance electrode and not the stretch impedance electrode. As a consequence, the pressure impedance will not change with external changes in the near field, but the stretch impedance will be sensitive to external changes in the near field. As a consequence, the stretch sensor will be able to do proximity and touch sensing while its use as a reference sensor is impacted.

Shielded stretch impedance as shown in FIG. 1C: In this embodiment, which is otherwise identical to the embodiment depicted in FIG. 1A, the active shield is applied just on the stretch impedance electrode and not the pressure impedance electrode. As a consequence, the stretch impedance will not change with external changes in the near field, but the pressure impedance will be sensitive to external changes in the near field. As a consequence, the pressure sensor will be able to do proximity and touch and pressure sensing.

Non shielded ISS without a shield electrode, as shown in FIG. 1D. In this embodiment, which is otherwise identical to the embodiment depicted in FIG. 1A, both sensing impedances (for example pressure and reference sensor) are affected by changes in the nearfield of the ISS. However, due to the nature of the two different sensors impedances, both are sensitive to the external influences and have a common signal (strongly related for both sensors) that is caused by the external field change and a part of the signal that is not correlated to the external field change (the signal changed caused by change in the applied pressure) which is only seen by the pressure sensor, not by the reference sensor. In this setup, the pressure reading can be filtered out by mathematical means and used as pressure information.

Although described herein with certain features highlighted in certain examples, those of skill in the art will understood that embodiments having fewer features or additional features, and embodiments with any combination or permutation of the various features, may be provided, even if not expressly described herein.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A sensor assembly comprising at least a first sensor and a second sensor, each of first sensor and the second sensor formed of stretchable, conformable materials:
the first sensor having a first sensing impedance relatively more sensitive to a first type of external influence than to a second type of external influence;
the second sensor having a reference impedance relatively less sensitive to the first type of external influence than the first sensor and relatively more sensitive to the second type of external influence than the first sensor;
the sensor assembly configured to derive a cumulative signal dependent on first external influence but independent from the second external influence based upon a comparison of the sensing impedance and the reference impedance.

2. The sensor assembly of claim 1, wherein the first sensor comprises a pressure sensitive impedance (PSI) sensor and the first type of external influence comprises a compression pressure, and the second sensor is a stretch sensitive impedance (SSI) sensor and the second type of external influence is a lateral stretching influence, each of the at least two sensors is attached to a conformable electrical wire, and each of the at least two sensors is enveloped in a conformable electrical insulation layer, the at least two sensors collectively disposed in a stack or in close proximity to one another, and each of the at least two sensors connected to a shared common reference electrode.

3. The sensor assembly of claim 2, further comprising readout electronics connected to the PSI sensor, the SSI sensor, and the reference electrode, the readout electronics configured to read impedance signals from the PSI and SSI sensors to reduce externally induced signal shifts and cross sensitivity effects.

4. The sensor assembly of claim 2, wherein the PSI sensor is more sensitive to mechanical effects of pressure than the SSI sensor, and the SSI sensor is more sensitive to mechanical effects of stretch than the PSI sensor, but both the PSI sensor and the SSI sensor are sensitive to at least one other common stimuli such that external disturbances in the at least one other common stimuli relating to correlated changes in both signals are canceled out by algorithmic calculations performed by the readout electronics.

5. The sensor assembly of claim 2, further comprising a shielding electrode connected to the readout electronics and covering the collectively disposed PSI and SSI on one side, wherein the shielding electrode renders impedance of one or both of the SSI and the PSI insensitive or sensitive to external capacitive field changes.

6.-10. (canceled)

11. The sensor assembly of claim 2, further comprising an electrode configured to detect proximity to an approaching object.

12. The sensor assembly of claim 3, comprising a plurality of conformable impedance sensing system units in the form of a matrix, each conformable impedance sensing unit comprising a unit PSI sensor and a unit SSI sensor connected to a unit reference electrode.

13.-18. (canceled)

19. The sensor assembly of claim 1, wherein the first sensor comprises a first electrode layer that is at least partially conductive, a second electrode layer that is at least partially conductive, and a dielectric layer arranged between the first electrode layer and the second electrode layer, wherein said electrode layers and the dielectric layer extend in parallel planes.

20. The sensor assembly of claim 19, wherein the dielectric layer comprises a compressible sensing portion.

21. The sensor assembly of claim 20, wherein the dielectric layer compressible sensing portion comprises at least one void filled with air or another gas.

22. The sensor assembly of claim 19, wherein the first electrode layer has a conductive sensing area forming a sensing capacitor and having a having a first surface area facing the first electrode layer, and a conductive reference area separated from the sensing area by an insulating area and forming the reference capacitor, the conductive reference area having a second surface area facing the second electrode layer corresponding in size to the first surface area.

23. (canceled)

24. The sensor assembly of claim 22, wherein the dielectric layer has an incompressible reference portion arranged between the reference area and the opposing area of the second electrode layer.

25. (canceled)

26. (canceled)

27. The sensor assembly of claim 24, wherein a thickness of the reference capacitor in a direction perpendicular to the reference area differs from a thickness of the sensing capacitor in a direction perpendicular to the sensing area.

28.-42. (canceled)

43. The sensor assembly of claim 12, wherein the pressure sensor is connected to an external device configured to charge one or both of the sensing capacitor and a reference capacitor and to discharge one or both of the sensing capacitor and the reference capacitor to a collecting capacitor.

44. The sensor assembly of claim 43, wherein the collecting capacitor has a capacitance greater than a capacitance of one or both of the sensing capacitor and the reference capacitor and the external device is configured to determine a first number of charge-discharge cycles needed to charge the collecting capacitor to a predetermined electric potential via the sensing capacitor as a cumulative signal, and a second number of charge-discharge cycles needed to charge the collecting capacitor to a predetermined potential via the reference capacitor after the reference capacitor and the collecting capacitor have been discharged as a reference signal, and to determine external pressure by processing the first number and second number of charge-discharge cycles.

45. (canceled)

46. (canceled)

47. The sensor assembly of claim 24, wherein the first electrode layer, the second electrode layer, and the dielectric layer are formed of stretchable materials, wherein the dielectric layer comprises air and a second material that is elastic and conformable but not compressible, the second material defining a plurality of pillar structures separated by air gaps, wherein deformability of the pillar structures renders the dielectric layer compressible as a whole.

48.-52. (canceled)

53. The sensor assembly of claim 12, wherein the matrix of conformable impedance sensing system units further comprises at least one other sensor in addition to a plurality of conformable impedance sensing units, the at least one other sensor comprising a wearable sensor selected from the group consisting of: a temperature sensor, a moisture sensor, a bio-impedance sensor, an electrode to sense an electric field of a human body, a movement sensor, an acceleration sensor, a position sensor, an ambient air pressure sensor, and combinations of any or all of the foregoing.

54. (canceled)

55. The sensor assembly of claim 53, wherein the readout electronics are accessible via a mobile device having a processor and memory embodying machine readable instructions causing the processor to collect data from the matrix of sensors.

56. (canceled)

57. The sensor assembly of claim 12, comprising a first conformable impedance sensing system unit having a first uninsulated body electrode configured for contact with a human body for sensing an electrical field generated by the human body, and a second conformable impedance sensing system unit having a second uninsulated body electrode configured for contact with the human body for sensing the electrical field generated by the human body, the first and second sensor assemblies, in combination, configured for detecting an electrocardiogram signal and a pressure exerted by the body electrode against the human body.

58. The sensor assembly of claim 57, comprising five conformable impedance sensing system units, each having a respective uninsulated body electrode configured for contact with a human body for sensing an electrical field generated by the human body, the respective uninsulated body electrodes disposed in a predetermined arrangement and connected to a processor configured to form a 12-channel electrocardiogram.

59.-61. (canceled)
